(19) United States
(12) Patent Application Publication
(10) Pub. No.: US 2014/0069253 A1
(43) Pub. Date: Mar. 13, 2014

(54) Apparatus for Grooving Cardboard Cuttings

(71) Applicant: Kolbus GmbH & Co., KG, Rahden (DE)

(72) Inventors: Klaus Gerke, Bassum (DE); Leonid Ugorets, Rahden (DE)

(73) Assignee: Kolbus GmbH & Co., KG, Rahden (DE)

(21) Appl. No.: 14/015,403

(22) Filed: Aug. 30, 2013

(30) Foreign Application Priority Data
Sep. 12, 2012 (DE) 10 2012 018 024.1

(51) Int. Cl. B26D 3/06

(52) U.S. Cl. CPC B26D 3/065
USPC 83/875

(57) ABSTRACT

An apparatus (1) for grooving cardboard cuttings (2, 141) while the cuttings are transported past at least one groove cutting tool (72′, 72″, 72′″). The tool or tools are situated on a guide element (78, 80, 130) that can be moved relative to the transport device during the operation of the grooving apparatus. During a grooving operation, the position of the groove cutting tool along the surface of the cutting and/or its distance from the transport device, can be varied such that completely new designs of mechanically grooved cardboard cuttings can be realized. According to the grooving method at least one groove cutting tool is moved transverse to the transport direction of the cardboard cuttings while the cardboard cuttings are transported past the groove cutting tools.

### BACKGROUND

The present invention pertains to an apparatus and a method for grooving cardboard cuttings.

Book cases, as well as boxes for high-quality sales and gift packages, essentially consist of cardboards that are lined with cloth materials. In order to prepare bending points or sharp-edged bends, the cardboard cuttings are grooved at the corresponding locations. The groove cross section may have any profile from triangular to rectangular that is cut out of the cardboards in the form of waste with knife blades that are accordingly aligned relative to one another or circular knives and, if applicable, an intermediately arranged lift-out device or with one-piece special knives that are shaped in accordance with the respective cross section.

CN 101200091 B discloses a corresponding cardboard grooving machine with a driven transport drum and belts that are partially wrapped around the transport drum, wherein several groove cutting tools that can be stationarily positioned between the belts on the circumference of the transport drum are provided for cutting grooves that respectively extend parallel to one another. The groove cutting tools are respectively composed of two knife blades that are mounted on a knife holder, wherein the knife holders are situated on clip-on holders clamped onto one of two crossbeams. In order to position the groove cutting tools, the clip-on holders are manually displaced on the crossbeams axially to the transport drum and fixed in position. The groove depth is adjusted by means of a knurled thumb screw that effectively displaces the knife holder on the clip-on holder radially to the transport drum.

The stationarily positioned groove cutting tools only make it possible to produce continuous grooves that extend parallel to the transport direction of the cardboard cuttings and have a constant cross section. However, there is a need to produce grooves sectionally, particularly in folding box constructions that consist of lined cardboard cuttings.

### SUMMARY

It is the object of the present invention to provide an apparatus and a method for grooving cardboard cuttings that achieve increased flexibility and allow diverse designs of grooved cardboard cuttings.

A significantly improved flexibility of the grooving apparatus can be achieved with at least one groove cutting tool arranged in the apparatus on a guide element that can be moved relative to the transport drum and driven by a drive element during the operation of the grooving apparatus. The axial position of the at least one groove cutting tool on the transport drum and/or its distance from the drum surface can be purposefully varied during a grooving process, i.e., while a cardboard cutting is moved past the groove cutting tools. This makes it possible to realize completely new designs of mechanically grooved cardboard cuttings that until now had to be elaborately produced by hand or could not be produced at all. Cross sections that change along a groove or grooves that extend only sectionally and/or obliquely to one another provide new design options and functionalities for the boxes and book cases manufactured of the grooved cardboard cuttings.

If the guide element can be moved and driven radially to the transport drum, it is possible to cut non-continuous grooves with ends and/or interruptions that are spaced apart from the cardboard edge along the groove. In this case, the respective groove cutting tool effectively is moved forward and backward from a cutting position into a raised position, in which it is lifted off the cardboard cutting, and/or vice versa while the cardboard cutting is moved past the groove cutting tool. For this purpose, the guide element in the form of a rocker or slide may be driven by a simple pneumatic cylinder. Grooves with a variable cross section along the respective groove can be cut by moving the groove cutting tool into cutting positions, in which it is spaced apart from the transport drum by different distances.

If the guide element includes a slide that can be displaced and driven axially to the transport drum, it is possible to produce grooves that extend obliquely to one another and/or to the cardboard edge by continuously moving the respective groove cutting tool transverse to the cardboard transport direction in accordance with the progression of the groove during the groove cutting process.

If the groove cutting tool is arranged on a guide element in the form of a cross-support, the groove cutting tool can be independently displaced radially and axially to the transport drum in order to simultaneously realize the aforementioned groove characteristics as a result of these axial and radial motions.

Respective groove cutting tools may be individually arranged and driven on separate guide elements or, according to an enhancement, arranged in pairs or groups on a common guide element and driven by a common drive in order to produce the respective aforementioned groove characteristics several times in an identical fashion.

The motion of the guide element preferably can be adjusted or changed. This makes it possible to flexibly produce grooves that are variable with respect to their cross section and/or progression.

The advantages of a particularly high flexibility and optional automation are achieved due to the fact that the drive element consists of a controllable drive. The controllable drive is preferably connected to the drive of the transport drum by means of a control device. Due to the continuous balance with the transport motion of the cardboard cutting, the beginning and the end of the grooves, the progression and/or desired cross-sectional changes can be produced in the cardboard cutting in a positionally accurate fashion. If the motion of the guide element is controlled or variably controlled in accordance with a groove pattern that is defined by the shape and/or dimensions of a collapsible cardboard product manufactured of the cardboard cutting to be grooved, the grooves can be cut automatically without manual adjusting and refinishing processes by specifying the groove pattern resulting from the desired box. A particularly accurate motion control is achieved with a drive element in the form of a controlled electric motor. In addition to step angle-controlled electric motors, it is also possible to utilize linear motors, torque motors, moving coils (voice coils) or similar controllable electric drives. The guide element preferably can be driven in accordance with a curve in a program-controlled fashion. In this way, it is possible, in particular, the cut groove progressions that deviate from a straight line in a geometrically accurate fashion. If the curve can be varied, it is possible to flexibly produce grooves that are variable with respect to their progression.

If the groove cutting tool comprises a scoring knife, it is possible to produce interrupted scores comparable to a perforation or sectional scores that define, e.g., a window cutout. If the scoring knives are adjusted to a corresponding depth, only a minimal residual cross section remains and can be very easily separated in subsequent production steps in order to remove corresponding sections or cutouts from the cardboard cuttings. Consequently, the punching of cardboard cuttings can be eliminated.

According to the inventive method, at least one groove cutting tool is moved transverse to the transport direction of the cardboard cuttings while the cardboard cuttings are transported past the groove cutting tools. The inventive method for producing cross sections that vary along a groove or grooves that only extend sectionally and/or obliquely to one another is not only suitable for drum-type grooving machines, but also for linearly conveying grooving machines such as table grooving machines, in which the cardboard cuttings are transported on a linearly moving vacuum table, or grooving machines, in which the cardboard cuttings are transported by being clamped between several successively arranged pairs of transport rollers.

The at least one groove cutting tool can be moved perpendicular to the cardboard cutting, preferably forward and backward from a cutting position into a raised position, in which it is lifted off the cardboard cutting, and/or vice versa in order to produce sectionally extending grooves. Grooves that extend obliquely to one another or to the cardboard edge can be produced by moving the at least one groove cutting tool perpendicular to the transport direction in the plane of the cardboard cutting.

### BRIEF DESCRIPTION OF THE DRAWING

Exemplary embodiments and applications of the inventive grooving apparatus and the method are described in greater detail below with reference to the following figures.

In these figures:

FIG. 1 shows a schematic side view of a grooving apparatus with a groove cutting tool that essentially can be moved radially;

FIG. 2 shows the groove cutting tool according to FIG. 1 in the raised position;

FIG. 3 shows an alternative design of a radially movable groove cutting tool;

FIG. 4 shows a partially schematic perspective representation of a detail of a grooving apparatus with a groove cutting tool that is mounted on a cross-support;

FIG. 5a shows a cardboard cutting that was sectionally grooved with the inventive grooving apparatus, and

FIG. 5b shows a box manufactured of the grooved cardboard cutting according to FIG. 5a.

### DETAILED DESCRIPTION

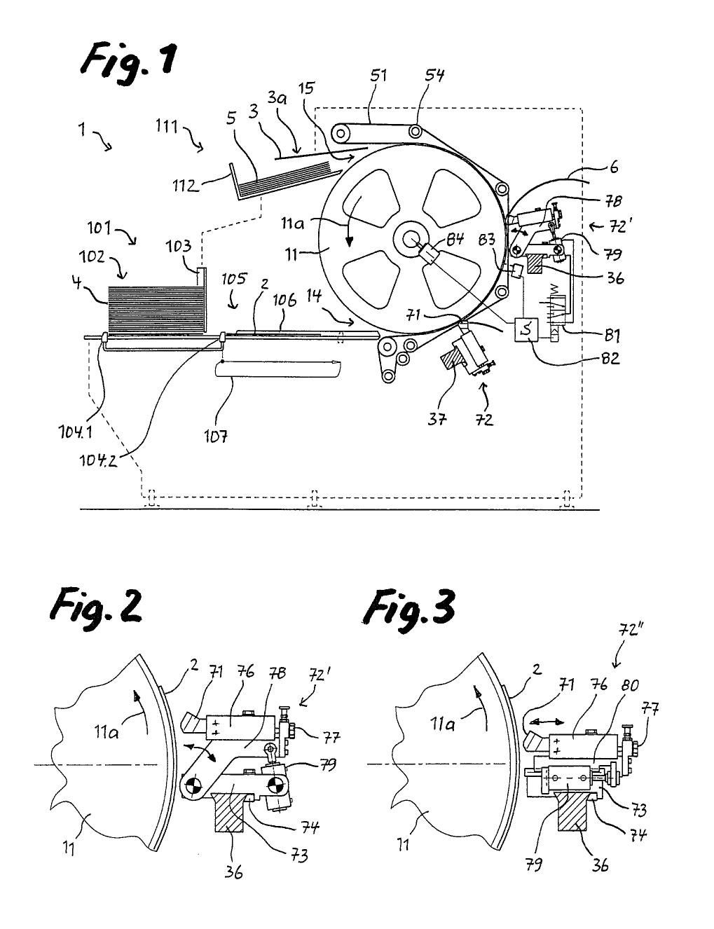

The grooving apparatus 1 schematically illustrated in FIG. 1 essentially consists of a driven, horizontally supported transport drum 11 and several spaced-apart endless belts 51 that revolve around rollers 54 and are partially wrapped around the transport drum 11 such that an infeed 14 and an outlet 15 are formed, as well as groove cutting tools 72, 72′ that are arranged between the belts 51 at a defined distance from the drum surface. Cardboard cuttings 2 transported to the infeed 14 by a feed device 101 are pressed onto the drum surface in an effectively conveying fashion by the belts 51 and transported from the infeed 14 situated at the lower vertex of the transport drum 11 to the outlet 15 situated at the upper vertex in the transport direction 11 a during an approximately 180° rotation of the transport drum 11, wherein the cardboard cuttings are during this process guided past groove cutting tools 72, 72′, at which, for example, a V-shaped waste section 6 is cut out of the cardboard cuttings 2 with correspondingly shaped grooving knives 71.

The feed device 101 in FIG. 1 features a cardboard magazine 102 that contains a stack 4 of cardboard cuttings that lie on top of one another. The respective bottom cardboard cutting 2 is ejected underneath a front stop 103 by a first cardboard pusher 104.1 and transferred into an intermediate position, from which the cardboard cutting 2 is transported to the infeed 14 by a second cardboard pusher 104.2 while being aligned on outer guide rails 106. The cardboard pushers 104.1, 104.2 are coupled at a fixed distance from one another and cyclically moved forward and backward with a constant transport stroke 107 that corresponds to this fixed distance. In this case, the transport speed is slightly higher than the rotational speed of the transport drum 11 such that the cardboard cuttings 2 effectively are forcibly pushed into the infeed 14 between transport drum 11 and belt 51.

The delivery 111 in FIG. 1 features a delivery table 112 that slopes obliquely forward, wherein the completely grooved cardboard cuttings 3 exiting the outlet 15 are dropped onto said delivery table and placed on top of one another in order to form a stack 5. Since the outlet 15 is arranged at the upper vertex of the transport drum 11, the cut grooves 3 lie on the upper side of the exiting cardboard cuttings 3 and therefore are visible to the operator.

According to FIG. 1, the rollers 54 are arranged around the transport drum 11 in such a way that a total of three areas of closest approach between the segments that lie between the rollers 54 and the belt sections adjoining the transport drum 11 are formed. The groove cutting tools 72, 72′ may be arranged in these areas. The groove cutting tools 72, 72′ are mounted on supporting beams 36, 37 that lie parallel to the transport drum 11. Several groove cutting tools 72, 72′ may be mounted adjacent to one another. Grooves 3a that lie very close to one another can be produced due to the arrangement on two supporting beams 36, 37 that lie behind one another in the transport direction 11a.

FIG. 2 shows the inventive groove cutting tool 72′ according to FIG. 1 on an enlarged scale. It consists of a carrier 73 that can be fixed on the supporting beam 36 with a clamping block 74. A rocker 78 is supported on the carrier 73 and a receptacle slide 76 for the grooving knife 71 is mounted on the rocker. The rocker 78 is driven by a pneumatic cylinder 79 such that the grooving knife 71 is essentially moved back and forward between the cutting position illustrated in FIG. 1 and the raised position according to FIG. 2, in which it is lifted off the cardboard cutting 2, radially to the transport drum 11.

After loosening the clamping block 74, the groove cutting tool 72′ can be displaced axially referred to the transport drum 11 such that the position of the groove 3a to be cut in the cardboard cutting 3 can be changed. In addition, the receptacle slide 76 can be released and displaced in an infinitely variable fashion radially to the transport drum 11 by means of a dial 77 such that a respective cutting depth can be adjusted in the cutting position.

The pneumatic cylinder 79 is controlled by a pneumatic valve 81 that is connected to a control device 82, in which the signals of a rotary encoder 84 that senses the rotational motion of the transport drum 11 and of a light barrier 83 that senses the front edge of the cardboard cutting 2 passing through the apparatus are processed in order to exactly determine the position of the cardboard cutting 2. Since the groove cutting tool 72′ and the grooving knife 71 can be moved from a cutting position into a raised position, in which they are lifted off the cardboard cutting 2, and vice versa in a respectively exact transport position while the cardboard cutting 2 passes through the apparatus, it is possible to cut non-continuous grooves with ends and/or interruptions that are spaced apart from the cardboard edge along the groove.

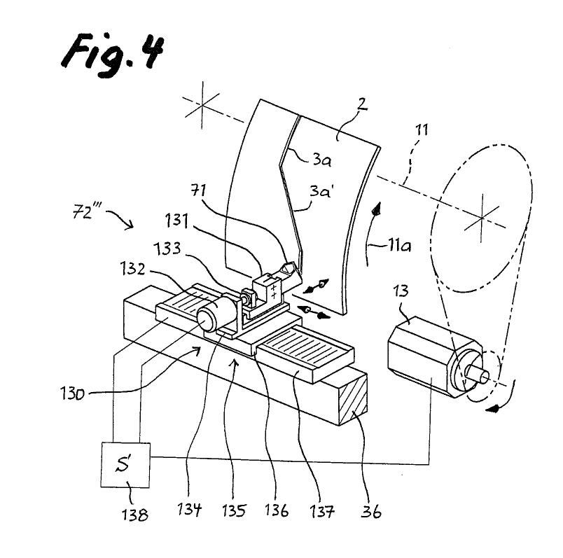

FIG. 3 shows an alternative embodiment of a radially movable groove cutting tool 72″. A slide 80 that can be displaced radially to the transport drum 11 is guided on the carrier 73 and the receptacle slide 76 for the grooving knife 71 is arranged on said slide. The slide 80 and the grooving knife 71 are driven by the pneumatic cylinder 79 arranged parallel to the linear guide.

FIG. 4 shows a third embodiment of a groove cutting tool 72″'. It is mounted on a driven cross-support 130 consisting of a slide 136 that is driven axially referred to the transport drum 11 and a receptacle slide 131 for the grooving knife 71 that is guided and driven radially to the transport drum 11 on a carrier 134 arranged on the slide 136. The receptacle slide 131 is driven by a servomotor 132 via a spindle-nut drive 133. In this way, the grooving knife 71 can be moved into cutting positions, in which it is spaced apart from the transport drum 11 by different distances and grooves with a variable cross section along the respective groove can be cut.

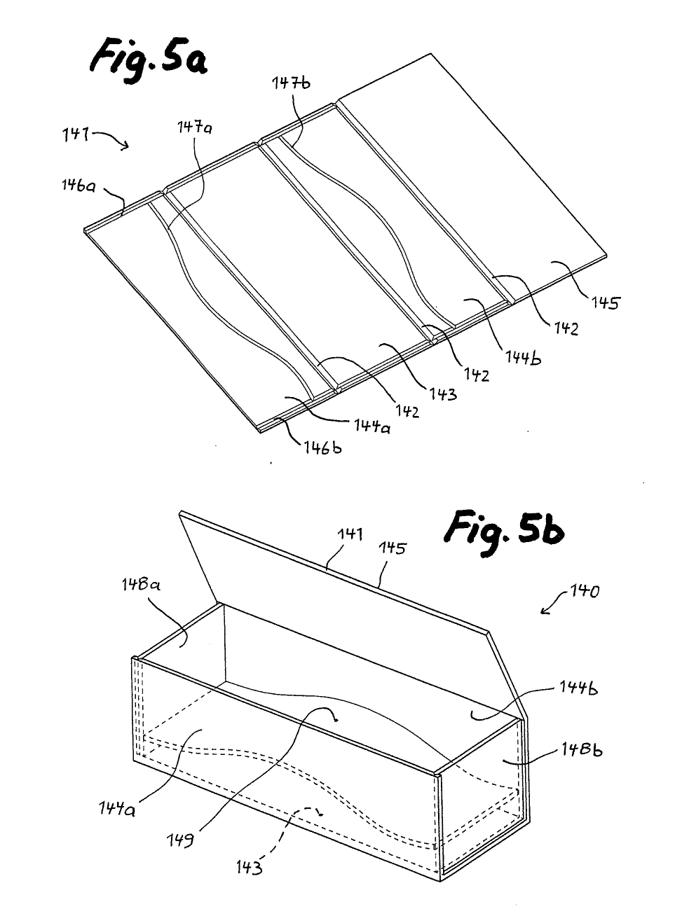

The slide 136 is realized in the form of a rotor or secondary component 136 of a linear motor 135 and guided axially to the transport drum 11 on the primary component 137 that acts as a stator and is mounted on the supporting beam 36. Both drives, namely the servomotor 132 for the radial motion and the linear motor 135 for the axial motion of the grooving knife 71, are connected to the driving motor 13 of the transport drum 11 by means of a control device 138. This results in a particularly high flexibility with respect to cutting grooves that are spaced apart from the cardboard edge, interrupted grooves, obliquely extending grooves and/or grooves with varying cross section. In this respect, see also the preceding explanations in the description of advantages. The production of a groove section 3a′ that extends obliquely to the transport direction 11a is illustrated as an application example in FIG. 5. Grooves 3a′ that extend obliquely to one another are required, for example, for manufacturing asymmetric collapsible boxes.

An example of a cardboard cutting that was grooved by means of the grooving apparatus 1 in accordance with the inventive method is illustrated in FIG. 5a. FIG. 5a shows a flat cardboard cutting 141 intended for a box 140. A bottom panel 143, two opposing sidewalls 144a, b arranged on the bottom panel 143 and a cover panel 145 are formed in the cardboard cutting 141 by means of several V-grooves that were produced lengthwise. Transversely extending grooves 146a, b were not produced continuously, but rather cut into the bottom panel 143 and the two sidewalls 144a, b only. In addition, the cardboard cutting 141 also contains two grooves 147a, b that were produced in the sidewalls 144a, b mirror-symmetric to one another in an undulating fashion.

In order to manufacture the cardboard cutting 141 illustrated in FIG. 5a, the V-grooves 142 and 147a, b that essentially extend lengthwise are produced in a first processing step. The grooving knives 72′″ for cutting the grooves 147a, b are moved back and forward transverse to the transport direction 11a of the cardboard cutting 141 in accordance with the undulating shape during the groove cutting process. The transversely extending grooves 146a,b are then produced in a second processing step, in which the cardboard cuttings 141 are fed to the grooving apparatus 1 after they were subjected to a 90° rotation. In this case, the groove cutting tools 72′, 72″ or 72′″ are respectively moved away from the transport drum 11 from a cutting position into a raised position, in which they are lifted off the cardboard cutting 141, in order to exclude the cover panel 145.

FIG. 5b shows a box 140 manufactured of the grooved cardboard cutting 141. The sidewalls 144a, b are positioned upright. Separate sidewalls 148a, b are inserted into the grooves 146a, b with key and slot joints and glued to the cardboard cutting 141. An intermediate bottom 149 with the curvature defined by the grooves 147a, b is accommodated in the undulating grooves 147a, b. Curvate sidewalls may be glued on the box in the same fashion.

Boxes joined by means of key and slot joints have a high stability. The joining principle furthermore allows considerable manufacturing tolerances of the individual components because dimensional and geometrical deviations are concealed by the grooves. Furthermore, curvate sidewalls and (intermediate) bottoms and non-cuboid box constructions can be realized in connection with the inventive grooving method.

1. An apparatus (1) for grooving cardboard cuttings (2, 141), comprising:
a horizontally supported transport drum (11) and operatively associated rotational drive (13);
a plurality of spaced-apart endless belts (51) that revolve around rollers (54) and are partially wrapped around the transport drum (11) such that an infeed (14) and an outlet (15) are formed and the cardboard cuttings (2, 141) are pressed against the drum surface in an effectively conveying fashion;
a plurality of groove cutting tools (72, 72′, 72″, 72′″) positionable between the belts (51) at the circumference of the transport drum (11);
at least one groove cutting tool (72′, 72″, 72′″) situated on a guide element (78, 80, 130); and
a drive element (79, 132,135) operatively associated with the guide element, for moving the guide element relative to the transport drum (11) during the operation of the grooving apparatus.

2. The apparatus according to claim 1, wherein the drive element drives the guide element (78, 80, 131) radially referred to the transport drum (11).

3. The apparatus according to claim 1, wherein guide element comprises a slide (136) and the drive element drives the slide axially referred to the transport drum (11).

4. The apparatus according to claim 1, wherein respective groove cutting tools (72′, 72″, 72′″) are arranged in groups on a common guide element and driven by a common drive element.

5. The apparatus according to claim 1, wherein the motion of the guide element relative to the transport drum is adjustable.

6. The apparatus according to claim 1, wherein the drive element comprises a controllable drive (79, 132, 135).

7. The apparatus according to claim 6, wherein the controllable drive (79, 132, 135) is operatively connected to the rotational drive (13) of the transport drum (11) by common control device (82, 138).

8. The apparatus according to claim 6 in combination with a cardboard cutting at the infeed to be grooved in a particular pattern and discharged at the outlet for subsequent collapse along the pattern of grooves to form a cardboard product, wherein the controllable drive is controlled to move the guide element (131, 136) in a pattern corresponding to the shape of said pattern of grooves.

9. The apparatus according to claim 6, wherein the drive element is programmable to drive the guide element (131, 136) along a predetermined curved path.

10. The apparatus according to claim 9, wherein the curve can be varied.

11. The apparatus according to claim 1, wherein the groove cutting tool comprises a scoring knife.

12. The apparatus according to claim 2, wherein guide element comprises a slide (136) and the drive element drives the slide axially referred to the transport drum (11).

13. The apparatus according to claim 12, wherein respective groove cutting tools (72′, 72″, 72″′) are arranged in groups on a common guide element and driven by a common drive element.

14. The apparatus according to claim 12, wherein the drive element comprises a controllable drive (79, 132, 135) and the drive element is programmable to drive the guide element (131, 136) along a predetermined curved path.

15. A method for grooving cardboard cuttings (2, 141) in an apparatus including a cuttings transport device (11); and an infeed (14) to and an outlet (15) from the transport device, whereby cardboard cuttings (2, 141) are continuously conveyed in a transport direction from the infeed to the outlet past groove cutting tools (72, 72′, 72″, 72″′), said method comprising that at least one groove cutting tool (72′, 72″, 72″) is moved transverse to the transport direction (11a) of the cardboard cuttings (2) while the cardboard cuttings are transported past the groove cutting tools.

16. The method according to claim 15, wherein the at least one groove cutting tool (72′, 72″, 72″′) is moved perpendicular to the cardboard cutting (2).

17. The method according to claim 15, wherein the at least one groove cutting tool (72′, 72″, 72′″) is moved back and forward from a cutting position into a raised position, in which it is lifted off the cardboard cutting, and/or vice versa.

18. The method according claim 15, wherein the at least one groove cutting tool (72′, 72″, 72′″) is moved perpendicular to the transport direction (11a) in the plane of the cardboard cutting (2).

19. The method according to claim 16, wherein the at least one groove cutting tool (72′, 72″, 72″′) is moved back and forward from a cutting position into a raised position, in which it is lifted off the cardboard cutting, and/or vice versa.

20. The method according claim 19, wherein the at least one groove cutting tool (72′, 72″, 72″′) is moved perpendicular to the transport direction (11a) in the plane of the cardboard cutting (2).
